(19) United States
(12) Patent Application Publication
(10) Pub. No.: US 2008/0212086 A1
(43) Pub. Date: Sep. 4, 2008

(54) Packaging Material Inspection Machine

(75) Inventor: Steven Antonacci, Jamesville, NY (US)

Correspondence Address: BOND, SCHOENECK & KING, PLLC, ONE LINCOLN CENTER, SYRACUSE, NY, 13202-1355, US

(73) Assignee: I. C. TECHNOLOGIES, INC., Dewitt, NY (US)

(21) Appl. No.: 11/566,994

(22) Filed: Dec. 5, 2006

Related U.S. Application Data
(60) Provisional application No. 60/597,505, filed on Dec. 6, 2005.

(51) Int. Cl. G01N 21/90; G01J 3/28

(52) U.S. Cl. 356/239.4; 356/51

(57) ABSTRACT

A machine for optically inspecting a transparent or semi-transparent workpiece composed of a material having a known, predetermined optical absorption property, that includes a light energy transmitting module having at least one light energy transmitting element disposed therein for transmitting light energy at a frequency tuned to the known, predetermined absorption property and along a predetermined axis, a support for securely engaging the workpiece and positioning it in the path of the predetermined axis, and a light energy collection module having a filter in tune with the known, predetermined absorption property and at least one light energy sensor contained therein, wherein the support is positioned between the light energy transmitting module and the light energy collection module.

### CROSS-REFERENCE TO RELATED APPLICATIONS

This application claims priority to U.S. Provisional Patent Application Ser. No. 60/597,505, filed on Dec. 6, 2005.

### BACKGROUND OF THE INVENTION

1. Field of the Invention

The present invention relates to material inspection machines, and more particularly to machines used to inspect transparent or semi-transparent packaging material for certain types of defects prior to the packaging material being filled with content.

2. Description of the Related Art

In certain industries (e.g., pharmaceutical), it is necessary that the packaging material in which the product is supplied to the consumer be inspected for defects prior to the contents being sealed in the package. For instance, the Food and Drug Administration has recommended to pharmaceutical manufacturing companies that the packaging lid and base materials in which drugs are contained be inspected prior to final assembly for the presence of defects, such as micron sized pinholes that could affect the product's sterility and integrity. The present Applicant, I.C. Technologies, Inc., of DeWitt, N.Y., sells the INTELLISCAN pinhole detector machine that performs pinhole inspections of foil type (or other non-transparent type) lid and base materials used in pharmaceutical packaging. In highly simplified terms, the INTELLISCAN detector operates by having web of packaging material pass between a light emitting station and a light collection station, wherein any light that actually passes through the foil material would be sensed by the collection station with the resultant data being transmitted to an alarm mechanism that would provide the indication that a pinhole was present in the material (the premise being that if there was not a hole, the light would not pass through the foil type material.)

While current, state of the art inspection technology for non-transparent packaging material is known, there remains a need for inspection tools that can detect defects in transparent/semi-transparent materials, such as PVC and PVDC. In addition, detecting defects in the sidewalls of bubble/blister packages is also not possible with pre-existing tools.

### BRIEF SUMMARY OF THE INVENTION

It is therefore a principal object and advantage of the present invention to provide a material inspection device that is capable of detecting certain types of defects in transparent and semi-transparent materials.

It is a further object and advantage of the present invention to provide a material inspection device that can detect defects in sidewalls of bubble/blister packages,

It is an additional object and advantage of the present invention to provide a material inspection device that permits the inspection to be performed at high speeds and with the results being visually displayed in real time.

Other objects and advantages of the present invention will in part be obvious and in part appear hereinafter.

In accordance with the foregoing objects and advantages, the present invention provides a machine for optically inspecting a transparent or semi-transparent workpiece composed of a material having a known, predetermined optical absorption property, comprising a light energy transmitting module having at least one light energy transmitting element disposed therein for transmitting light energy at a frequency tuned to the known, predetermined absorption property and along a predetermined axis; a support for securely engaging the workpiece and positioning it in the path of the predetermined axis; and a light energy collection module having a filter in tune with the known, predetermined absorption property and at least one light energy sensor contained therein, wherein the support is positioned between the light energy transmitting module and the light energy collection module.

### BRIEF DESCRIPTION OF THE DRAWINGS

The present invention will be more fully understood and appreciated by reading the following Detailed Description in conjunction with the accompanying drawings, in which:

FIG. 1 is a perspective view of the present invention;

FIG. 2 is a block diagram schematically illustrating the components and interrelationships in the present invention;

FIG. 3 is a first perspective view of the present invention with the cover removed from the light transmitting module;

FIG. 4 is a second perspective view of the present invention with the cover removed from the light transmitting module;

FIG. 5 is a front elevation view of the present invention;

FIG. 6 is a front elevation view of the graphical user interface associated with the present invention;

FIG. 7 is a plan view of the light transmitting module;

FIG. 8 is a side elevation view of the emitting element that is a part of the light transmitting module; and

FIG. 9 is a plan view of the light collecting module;

FIG. 9A is a cross-sectional view taken along line 4A-4A of FIG. 9.

### DETAILED DESCRIPTION OF THE INVENTION

Referring now to the drawings, wherein like reference numerals refer to like parts throughout, there is seen a machine, designated generally by reference numeral 10, for performing inspection of a transparent or semi-transparent workpiece 12. Machine 10 essentially comprises a light energy transmitting module 100, a light energy collection module 200, and a workpiece support platen 300 positioned between transmitting module 100 and collecting module 200.

To understand the significance of the elements comprising the present invention, it is first important to understand the material properties associated with a typical workpiece that is subject to the inspection functionality imparted by machine 10. Workpiece 12 is a clear or transparent, generic, thermoformed packaging material, such as PVC or PVDC, among others, that includes known, predetermined light energy absorption characteristics, and that is commonly used in the pharmaceutical packaging industry. Workpiece 12 is of a predetermined width and may be flat or be patterned with periodic bubbles/cavities 14 (in which a pill or capsule, for instance, may be encapsulated) that include sidewalls 16. To ensure the integrity and cleanliness of the product packaged in workpiece 12, it is necessary to inspect workpiece 12 to ensure that it does not contain any pinholes, fissures, blowouts, or other defects in quality, such as inconsistent thickness in the walls defining cavities 14.

Machine 10 is preferably, though not necessarily, structured with light transmitting module 100 extending along a horizontal axis A-A, light collection module 200 extending along a second horizontal axis B-B that is in spaced, parallel relation below axis A-A, and with workpiece support 300 being coincident with the upper surface of collection module 200, thereby placing it in between transmitting module 100 and collection module 200. Light transmitting module 100 includes at least one, and preferably a plurality of light transmitting elements 102, each of which transmits light energy along at least a substantially vertically extending axis X-X which intersects with workpiece support 300 and light collecting module 200. An example of a light transmitter element 102 that would work with the present invention is the IR-12 switch parabolic reflector sold by Hawkeye Technologies or the Tunable IR sold under the brand name MARKIR by Ion Optics.

Workpiece support 300 includes a pair of guides 302 each of which is sildably adjustable in laterally spaced relation to one another and along the top surface of light collection module 200. Guides 302 are manually spaced apart by a distance that is approximately the same as the width of workpiece 12, such that they engage the side edges of the workpice as it progresses through machine 10. Thus, as workpiece 302 comes off of a roll (or other supply), it is moved in linearly guided relation between light transmitting module 100 and light collection module 200 such that it is optically inspected for defects.

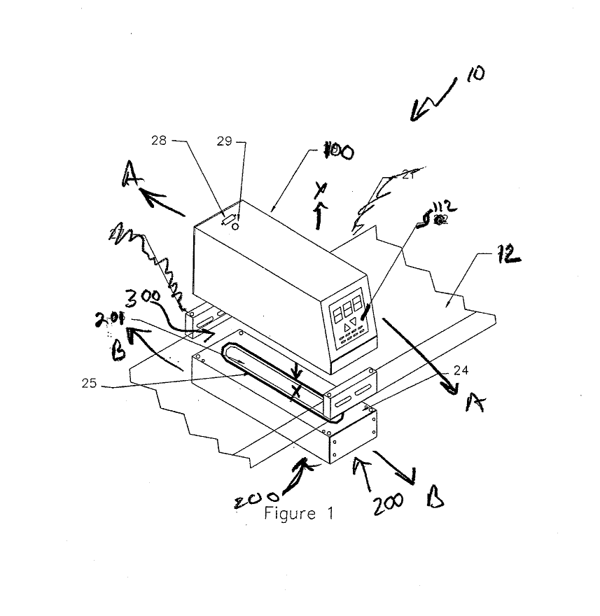

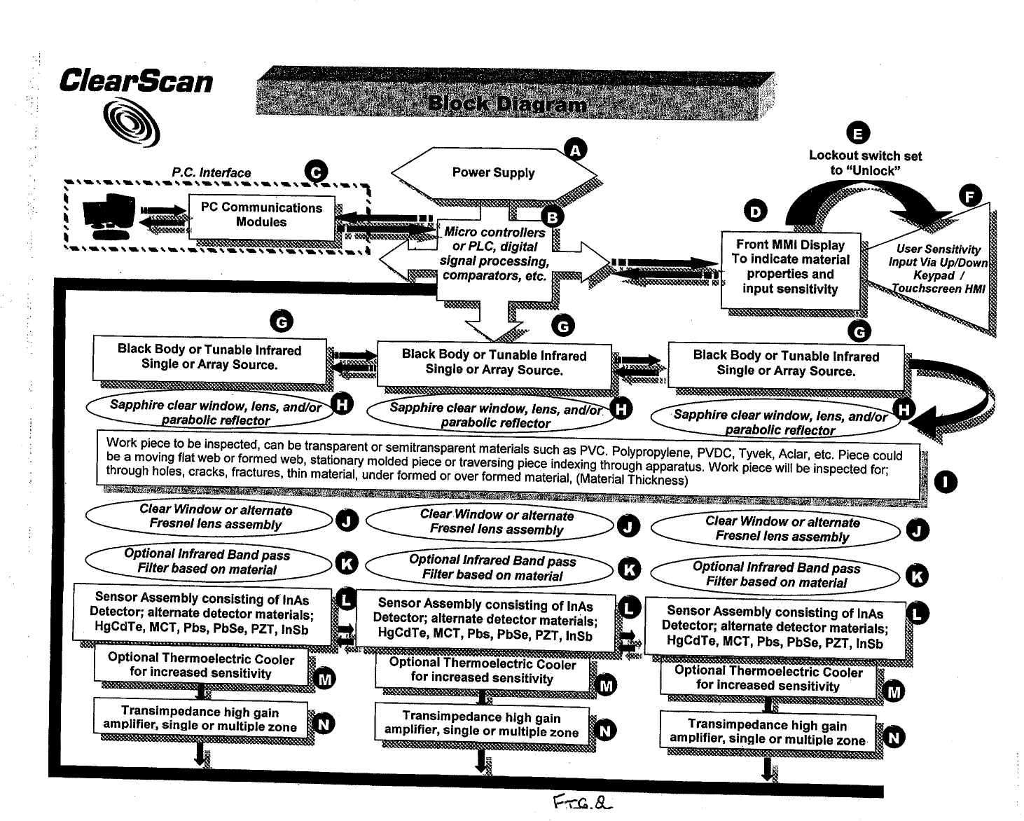

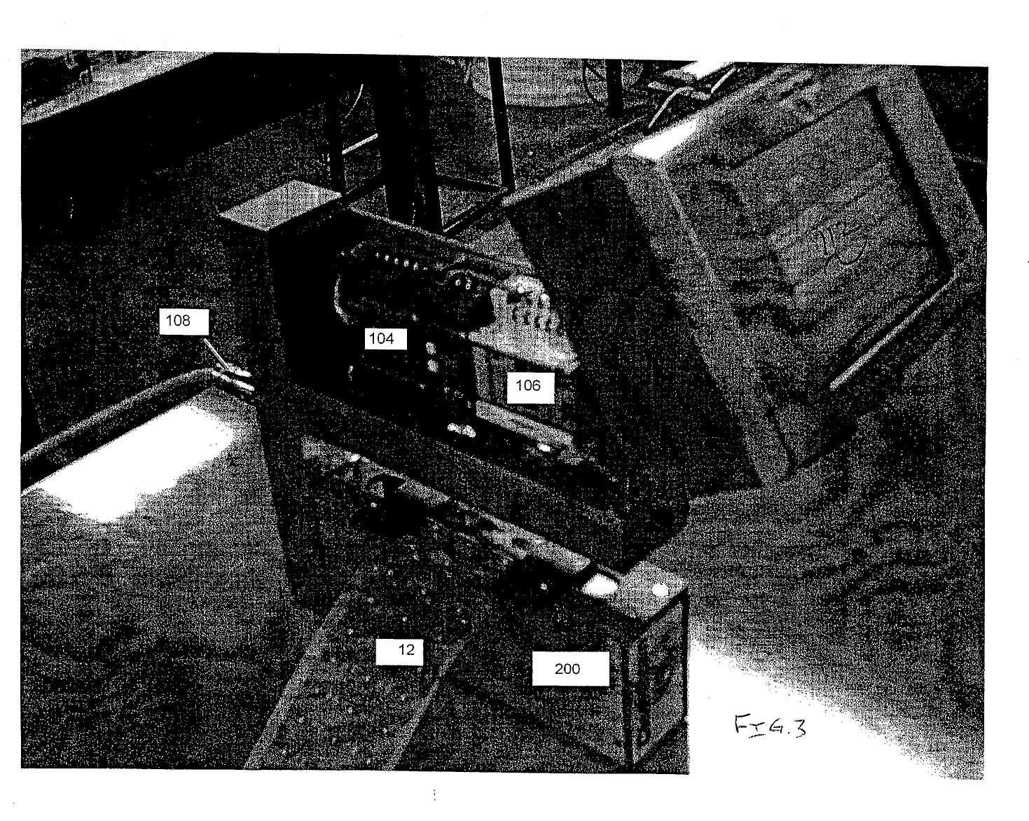

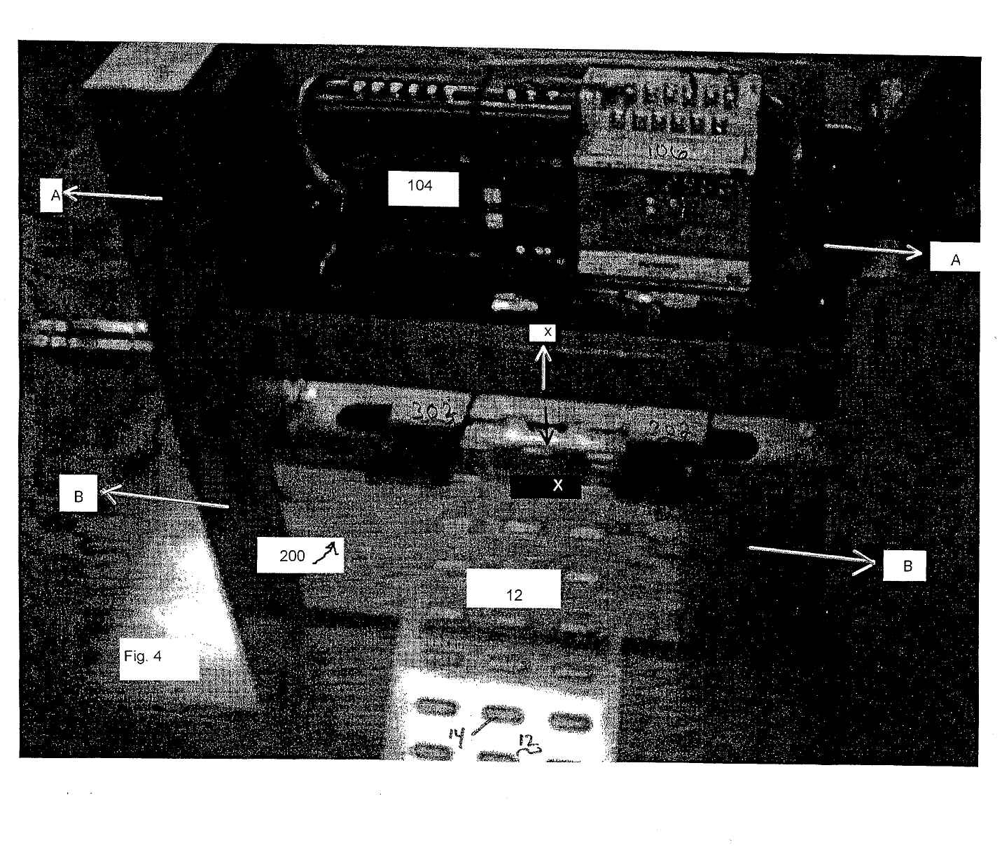

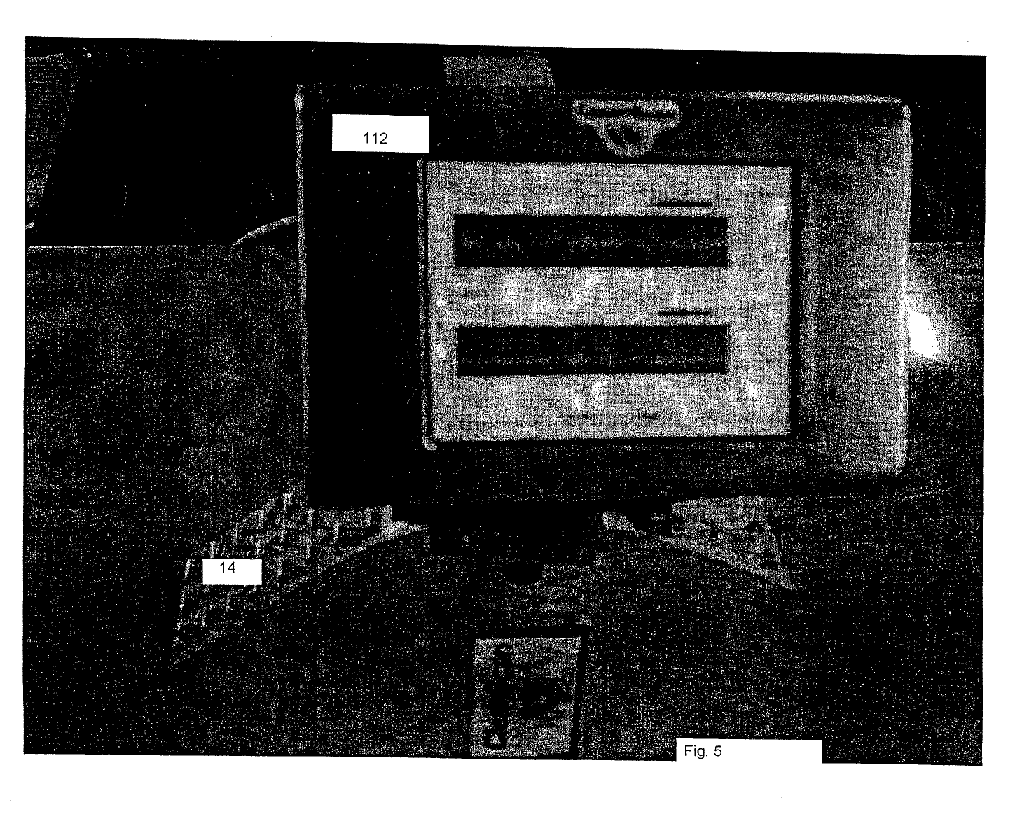

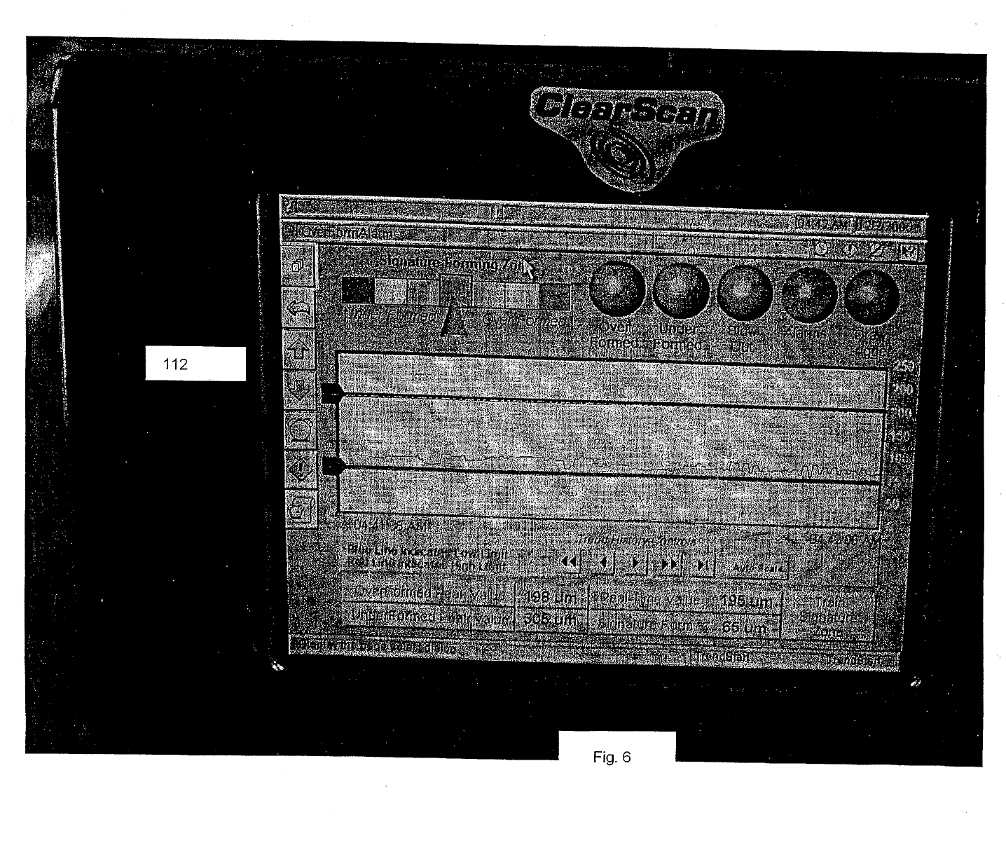

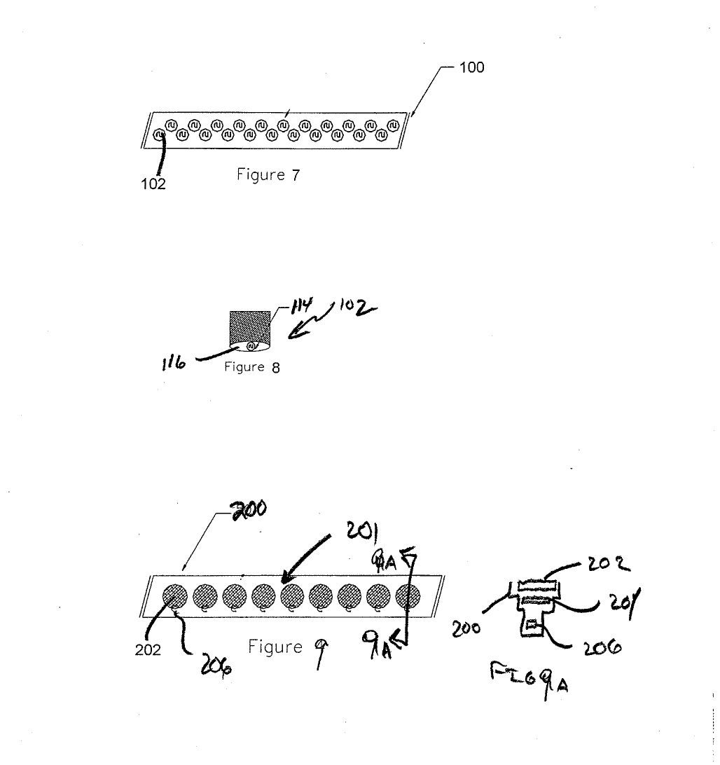

With reference to FIGS. 1, 2, 3 and 4, light transmitting module 100 includes light transmitting elements 102 housed therein, as well as a microcontroller (or programmable logic controller, digital signal processors, comparators, and the like) 104 and an amplifier 106, preferably a transimpedance high gain amplifier (based upon the number of zones being inspected on a workpiece 12), and a regulated power supply 108. A PC 110 may be interconnected to microcontroller 104 which may also include optional data acquisition boards for interfacing I/O signals therewith (signals including those representative of material thickness, material holes/cracks, multiple zone alarms, analog thresholds for sensitivity, and remote sensitivity lockout). In addition, a graphical user interface 112 is also provided. GUI 112 provides a MMI (man machine interface) to graphically indicate individual zone characteristics in real time, material properties and input sensitivity, and being capable of receiving user commands for setting alarm thresholds, graphical display options, and the like.

With reference to FIG. 8, light transmitting elements 102 include a tunable infrared source 114 (or array of sources), and a window, lens and/or parabolic reflector 116 for focusing the light on the workpiece 12. The emitted light energy is directed such that it encompasses a zone or zones of the workpiece 12 as it passes along the workpiece support 300. As the emitted light has optical characteristics that match the absorption property of the workpiece 12, any light that is not absorbed by workpiece 12 passes to light collecting module 200, as described below for processing.

Light collecting module 200 includes an upper surface with a clear window 201 in which is positioned an infrared (optical) bandpass filter 202 that is tuned to permit only light through having frequencies that match the absorption of the workpiece 12, a Fresnel lens (or equivalent focusing element) 204 positioned adjacent the filter 202, and a photovoltaic infrared or photoconductive sensor assembly 206 mounted beneath the lens 204, that includes a InAs detector (alternate detector materials include HgCdTe, MCT, Pbs, PbSe, PZT, silicon, and InSb depending on the IR range needed to be detected). Any light energy that is not absorbed by workpiece 12 passes to module 200, and if the energy has the optical characteristics that match the absorption properties of the workpiece 12, the energy will pass through filter 202 (any extraneous energy that does not match the absorption properties of the workpiece will not pass through filter 202). From there, the energy will be collimated by lens 204 which focuses the energy on a sensor 206. The sensor will receive the energy and transmit a signal representative of the energy level back to microcontroller 104 for processing (the energy can be processed and graphically represented in real time on GUI 108, and if it exceeds a predefined threshold, an alarm can be triggered and whatever desired remedial action can be taken). In addition to the foregoing, an optional thermoelectric cooler may be included to increase the unit's sensitivity, and a second transimpedance high gain amplifier to amplify the signal before passing to the microcontroller 104 for processing

What is claimed is:

1. An apparatus for inspecting for defects in a workpiece, comprising:
a. a light energy transmitting module for transmitting light energy at a predetermined frequency;
b. a light energy collection module including a filter tuned to the predetermined frequency and at least one light energy sensor for detecting energy at the predetermine frequency; and
c. a support positioned in the path of the transmitted light energy between said light energy transmitting module and said light energy collection module for securely engaging the workpiece.

2. The apparatus of claim 1, wherein said light energy transmitting module comprises a light emitting element.

3. The apparatus of claim 2, wherein said light emitting element comprises an infrared light source.

4. The apparatus of claim 1, wherein said light energy collecting module further comprises a lens positioned to focus the transmitted light onto said filter.

5. The apparatus of claim 1 further comprising a microcontroller interconnected to said light energy transmitting module and said light energy collection module.

6. The apparatus of claim 5, wherein said microcontroller is programmed to determine whether the light energy transmitted from said light energy transmitting module reaches said light energy collection module.

7. The apparatus of claim 6, wherein the light energy transmitted from said light energy transmitting module is in the infrared spectrum.

8. The apparatus of claim 7, wherein the workpiece comprises a moving web of packaging material.

9. An apparatus for inspecting for defects in a workpiece moving through the apparatus, comprising:
a. a light energy transmitting module including a light emitting element for transmitting light energy at a selected frequency;
b. a light energy collection module including a filter tunable to only allow light of the selected frequency to pass and at least one light energy sensor for detecting energy at the selected frequency; and
c. a support for securely engaging the edges of the workpiece at it moves through said apparatus and positioning the workpiece in the path of the transmitted light energy between said light energy transmitting module and said light energy collection module.
d. a microcontroller interconnected to said light energy transmitting module and said light energy collection module that is programmed to determine whether the light energy transmitted from said light energy transmitting module reaches said light energy collection module.

10. The apparatus of claim 9, wherein the microcontroller is programmed to select the frequency of the light energy transmitted from said light energy transmitting module.

11. The apparatus of claim 10, wherein the microcontroller is programmed to select the frequency of the light energy filtered by said filter.

12. The apparatus of claim 11, wherein the microcontroller is programmed to select the frequency of the light energy detected by said sensor.

13. The apparatus of claim 12, wherein the light energy transmitted from said light energy transmitting module is selected fall within the infrared spectrum.

14. A method of inspecting for defects in a workpiece, comprising the steps of:
transmitting light at a predetermined frequency;
positioning the workpiece in the path of the transmitted light;
filtering any of the transmitted light passing through the workpiece at the predetermined frequency; and
detecting whether any of the filtered light passing through the workpiece is at the predetermined frequency.

15. The method of claim 14, further including the step of selecting the predetermined frequency prior to transmitting light at the predetermined frequency.

16. The method of claim 15, further including the step of tuning the filtering of any of the transmitted light to the predetermined frequency.

17. The method of claim 16, further including the step of configuring the detecting the filtered light to the predetermined frequency.

18. The method of claim 17, further including the step of signaling the detection of filtered light in a human discernable manner.
